(19) United States
(12) Patent Application Publication
(10) Pub. No.: US 2025/0093246 A1
(43) Pub. Date: Mar. 20, 2025

(54) VISCOSITY SENSORS AND WIRELESS SMALL-SCALE SOFT ROBOTS

(71) Applicant: VANDERBILT UNIVERSITY, Nashville, TN (US)

(72) Inventors: Xiaoguang Dong, Nashville, TN (US); Boyang Xiao, Nashville, TN (US)

(21) Appl. No.: 18/882,837

(22) Filed: Sep. 12, 2024

Related U.S. Application Data
(60) Provisional application No. 63/616,961, filed on Jan. 2, 2024.
(60) Provisional application No. 63/582,879, filed on Sep. 15, 2023.

(51) Int. Cl. G01N 11/16

(52) U.S. Cl. CPC G01N 11/16

(57) ABSTRACT

Disclosed are various approaches for a sensor, having a rotating magnetic spinner disposed at a first end of a shaft and configured to rotate about the shaft. The sensor can include a foot disposed at a second end of the shaft and a plurality of microspikes disposed on a distal surface of the foot.

### CROSS-REFERENCE TO RELATED APPLICATIONS

This application claims priority to, and the benefit of U.S. Provisional Patent Application 63/582,879 entitled “SENSING MUCUS PHYSIOLOGICAL PROPERTY IN SITU BY WIRELESS MILLIMETER-SCALE SOFT ROBOTS” filed on Sep. 15, 2023, and U.S. Provisional Patent Application 63/616,961 entitled “SENSING MUCUS PHYSIOLOGICAL PROPERTY IN SITU BY WIRELESS MILLIMETER-SCALE SOFT ROBOTS” filed on Jan. 2, 2024, which are incorporated by reference as if set forth herein in their entirety.

### BACKGROUND

The physiological property of mucus is an important biomarker for monitoring the human health conditions and helping understand disease development, as mucus property such as viscosity is highly correlated with inflammation and other diseases. However, it remains challenging to sense mucus viscosity using pure medical imaging. Collecting and analyzing mucus samples in vitro using flexible endoscopes and capsule endoscope robots is also challenging due to their difficulty of accessing very confined, torturous, and small spaces, and the sample may not reflect the real mucus property.

### SUMMARY

In accordance with the purpose(s) of this disclosure, as embodied and broadly described herein, the disclosure, in various aspects, relates to viscosity sensors, wireless small-scale robots for sensor delivery, and methods of use thereof. The solutions described herein combine principles of biology, biomedical engineering, and mechanical engineering to arrive at novel solutions for placing a viscosity sensor in a gastrointestinal (GI) tract and sensing the viscosity of mucus in the GI tract.

Aspects of the present disclosure provide for methods and devices for sensing mucus viscosity in situ enabled by wireless miniature viscosity sensors actuated by magnetic fields and tracked by medical imaging. In addition, methods of delivering viscosity sensor by controlling a small-scale soft robot are provided for in the present disclosure. Embodiments of the present disclosure include: a sensor, having a rotating magnetic spinner and a foot with a plurality of microspikes; a soft robot having a magnetic robot body, a plurality of footpads, and a delivery member for placing a sensor; and a magnetic actuator which is capable of producing a rotating magnetic field to control the soft robot and the sensor.

The rotating magnetic spinner of the sensor can be disposed at a first end of a shaft and configured to rotate about the shaft. The foot of the sensor can be disposed at a second end of the shaft. The plurality of microspikes on the foot of the sensor can be disposed on a distal surface of the foot, or on the opposite side of the foot from the second end of the shaft. In some embodiments, the rotating magnetic spinner has a programmed magnetization profile. In some embodiments, the rotating magnetic spinner further comprises a magnetic ring disposed about the shaft and positioned near the first end of the shaft, and a magnetic disk disposed on the magnetic ring, where a planar surface of the magnetic disk is perpendicular to a longitudinal axis of the magnetic ring. According to various examples, the magnetic disk is an ellipse-shaped disk. The rotating magnetic spinner can be formed form a mixture of Polydimethylsiloxane (PDMS) and neodymium, iron, and boron (NdFeB) magnetic particles. Additionally, the sensor can further include a cap disposed at the first end of the shaft, where the cap has a hole configured to receive a delivery member.

The soft robot can have a magnetic robot body and a plurality of footpads, where individual footpads of the plurality of footpads are disposed at respective ends of the magnetic robot body. Additionally, the soft robot can include a delivery member having a first end connected to the magnetic robot body and a second end configured to attach to a sensor. In some embodiments, the magnetic robot body can be a shaft having a first end with a first footpad and a second end with a second footpad. The magnetic robot body can be formed from a mixture of silicone rubber, silicone gel, and NdFeB microparticles in a 3:1:8 ratio by weight. In some embodiments, the magnetic robot body has a programmed magnetization profile which can be configured to cause the magnetic robot body to perform a tumbling end-over-end motion when acted upon by a rotating magnetic field. In some embodiments, each of the plurality of footpads is formed from PDMS. Additionally, each of the plurality of footpads can be a half-spherical footpad having an adhesive coating, where the adhesive coating can be a chitosan-based bioadhesive. In some embodiments, the delivery member can include a connector rod extending from the second end of the delivery member, the connector rod configured to fit into a reciprocal hole on the sensor. The magnetic actuator can be configured to produce a rotating magnetic field. In some embodiments, the magnetic actuator is actuated to cause the soft robot to tumble to a designated location. The magnetic actuator can be actuated to cause the delivery member to position the sensor at the designated location, deliver the sensor to the designated location, and/or cause the rotating magnetic spinner to rotate.

Other systems, methods, devices, features, and advantages of the devices and methods will be or become apparent to one with skill in the art upon examination of the following drawings and detailed description. It is intended that all such additional systems, methods, devices, features, and advantages be included within this description, be within the scope of the present disclosure, and be protected by the accompanying claims.

### BRIEF DESCRIPTION OF THE DRAWINGS

Further aspects of the present disclosure will be more readily appreciated upon review of the detailed description of its various embodiments, described below, when taken in conjunction with the accompanying drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1E show a soft climbing robot enabled delivery of miniature sensors for in situ sensing of mucus viscosity. FIG. 1A shows the concept of a millimeter-scale soft robot for sensor delivery encapsulated by a swallowable capsule. FIG. 1B is an illustration of the soft climbing robot and viscosity sensor to be encapsulated in a capsule. The blue arrows on the magnetic robot body indicate its magnetization profile. The components of the viscosity sensor are a magnetic spinner, an adhesive patch for anchoring, and a shaft for rotational motion. FIG. 1C is an illustration of the climbing motion and deployment of the magnetic viscosity sensor on a mucus-covered soft tissue surface by controlling a soft climbing robot. FIG. 1D is an illustration of the deployment and tracking of multiple viscosity sensors for monitoring mucus viscosity spatiotemporally under medical imaging. FIG. 1E is images of a viscosity sensor anchored on porcine colon tissue with direct contact to the mucus layer. Scale bar, 500 μm.

FIGS. 2A-2H show controlling the robot climbing locomotion and the loading of viscosity sensors on soft tissues. FIG. 2A is an illustration of the omnidirectional steerability of the soft climbing robot on soft tissues by applying magnetic fields in different directions. FIG. 2B is an illustration of the peeling-and-loading mechanism to enable climbing on mucus-covered soft tissues. Yellow arrows: contact force. Blue arrows: net magnetic moment. Red arrows: external magnetic field. Orange arrows: magnetic torque. FIG. 2C shows video snapshots of the robot climbing locomotion on porcine colon tissues and the applied magnetic field in 3D. Scale bar, 2 mm. FIG. 2D shows video snapshots of the sensor-delivery process using the soft robot. Scale bar, 1 mm. FIG. 2E shows the angle between the external magnetic field and z-axis as a function of time during the delivery process. FIG. 2F shows the external magnetic field magnitude as a function of time during the delivery process. FIG. 2G shows the angle between robot body plane and the z-axis as a function of time during the delivery process. FIG. 2H shows the normal force applied on the sensor adhesive patch by the tissue surface as a function of time in the delivery process.

FIGS. 3A-3F show an example design of the sensor delivery mechanism. FIG. 3A is an illustration of the dimensions of a soft robot for delivering a viscosity sensor. Ob: the angle between the robot body plane and the delivery beam. Point O: the midpoint between the two footpads. Point S: the loading point of the viscosity sensor. d: the distance between point O and S. hᵣ: the height of the robot body. L_{b}: the length of the delivery beam. hₛ: the height of the viscosity sensor. FIG. 3B shows the maximum loading force generated by robots with different θ_{b}. The red shaded region indicates that the beam is too long and prevents robot locomotion. FIG. 3C is images of the delivery process for robots with θ_{b}=30°, 45° and 60°. The design marked by red box shows both sufficient loading force and robot climbing locomotion. Scale bars, 2 mm. FIG. 3D is an illustration of the delivery beam and the sensor with key design parameters. Dᵣ: The diameter of the rod on the delivery beam. Dₕ: the diameter of the hole on the viscosity sensor. FIG. 3E shows the required breaking force of the delivery beam and sensor with different Dᵣ/Dₕ. The green area marks the desired breaking force for both reliable navigation and feasible release of the sensor based on a loading force of 0.6 mN. Error bars represent the standard deviation for n=3 measurements. FIG. 3F shows video snapshots of the delivery process for robots with different Dᵣ/Dₕ. Scale bars, 2 mm.

FIGS. 4A-4H show a characterization of the anchoring force on porcine colon tissues. FIG. 4A is an image of the experiment measuring the normal anchoring force of a viscosity sensor on porcine tissues. Scale bar, 1 mm. FIG. 4B shows the normal anchoring forces for a sensor on porcine colon tissues under different preloads as a function of the cantilever beam displacement. FIG. 4C shows the maximum normal anchoring force for a sensor on porcine colon tissues under different preloads. FIG. 4D is an image of the experiment measuring the shear anchoring force of a viscosity sensor on porcine tissues. Scale bar, 1 mm. FIG. 4E shows the shear anchoring forces for sensors on porcine colon tissues with or without microspikes as a function of the cantilever beam displacement. FIG. 4F shows the maximum normal anchoring force for sensors with spikes and without spikes on porcine colon tissues. FIG. 4G is video snapshots of the sensor retention experiment on porcine tissues when flushed with water. Scale bar, 5 mm. FIG. 4H is video snapshots of the anchored viscosity sensor when subject to a cyclic dynamic load on the tissue. Scale bar, 5 mm. In FIGS. 4C and 4F, the error bars represent the standard deviation for n=3 measurements.

FIGS. 5A-5H show a characterization of viscosity sensing by the magnetically actuated viscosity sensor. FIG. 5A shows images of the experiment anchoring the viscosity sensor onto a mucus layer of porcine colon tissues. Scale 4 bar, 500 μm. FIG. 5B is an illustration of the rigid-body torques and forces applied on the magnetic spinner of the sensor. FIG. 5C is images of the sensor spinning in a honey-water mixture actuated by a rotating external magnetic field of different frequencies. The measured viscosity of the honey-water mixture is μₘ=2.7 Pa·s. Red line: magnetic field B. Blue line: magnetic moment of the magnetic spinner mₛ. Scale bar, 1 mm. FIG. 5D shows the orientation of the magnetic moment and external magnetic field for the viscosity sensing process. FIG. 5E is the sine of the angle difference between the magnetic field and magnetic moment for the viscosity sensing process. FIG. 5F shows the calibration curve for the component of the external magnetic field normal to the magnetic moment of the sensor probe at different shear rate. Error bars represent standard deviation for n=5 periods. FIG. 5G is the slope of the calibration curves for honey-water mixture with different viscosity. FIG. 5H is the predicted viscosity μₚ as a function of the measured viscosity μₘ for honey-water mixtures of different viscosities. The error bars represent the standard deviation for n=3 measurements.

FIGS. 6A-6K illustrate sensing mucus viscosity on porcine tissues ex vivo and robot locomotion under X-ray guidance. FIG. 6A shows sensor signal outputs as a function of the shear rate in mucus of varying water-mucin ratios. FIG. 6B shows the predicted mucus viscosity using the magnetic viscosity sensor and the measured viscosity using a commercial viscometer as a function of the shear rate. Water-mucin mixtures used have different mixing ratios of 1:7, 1:7.5, and 1:8 (mucin and water by weight). FIG. 6C shows the predicted time-varying mucus viscosity as a function of time with a shear rate of 0.15 s⁻¹. FIG. 6D shows a video snapshot of the viscosity sensing process for two sensors deployed on the top and vertical surfaces of porcine colon tissues. Scale bar, 1 mm. FIGS. 6E and 6F show the predicted mucus viscosity as a function of the shear rate for Sensor 1 (FIG. 6E) and Sensor 2 (FIG. 6F). FIGS. 6G-6J show a sequential X-ray medical images of the robot climbing porcine colon tissues and the sensor deployment process. FIG. 6G shows the climbing locomotion; FIG. 6H shows the sensor loading; FIGS. 6I and 6J show the sensor detaching. FIG. 6K shows sequential X-ray medical images of the viscosity sensing process with the deployed viscosity sensor. In all figures, scale bars, 1 mm.

FIGS. 7A and 7B show an illustration of the components and dimensions of the robot and viscosity sensor. FIG. 7A is an illustration of the components and dimensions of the soft climbing robot and the integrated delivery beam. FIG. 7B is an illustration of the components and dimensions of the viscosity sensor.

FIGS. 8A-8D show the fabrication process of the climbing robot. FIG. 8A is an illustration of the fabrication process for components of the soft climbing robot. FIG. 8B is an illustration of the fabrication process of the delivery beam, robot assembly and coating process for the soft climbing robot. FIG. 8C is an illustration of the fabrication process for components of the viscosity sensor. FIG. 8D is an illustration of the sensor adhesive patch coating for mucoadhesion.

FIG. 9 shows an example of climbing locomotion of the soft climbing robot on the porcine colon tissue treated with simulated gastric fluid. Simulated gastric fluid (SGF) is pipetted on the porcine colon tissue before the robot is attached to the tissue surface. Red arrow: external magnetic field. Scale bar, 1 mm.

FIGS. 10A and 10B show an experimental setup for measuring tissue anchoring force. FIG. 10A is an illustration of the experimental setup for measuring tissue anchoring forces with a cantilever beam. FIG. 10B is an image of the sensor probe attached to the cantilever beam interacting with the tissue. Scale bar, 2 mm.

FIG. 11 shows the maximum normal anchoring force on the porcine colon tissue treated with phosphate buffered saline and simulated gastric fluid. The phosphate buffered saline (PBS) and SGF are pipetted on the tissue surface before testing. Error bars represent standard deviation for n=5 periods.

FIG. 12 shows viscosity sensing curves for mucus mixed with phosphate buffered saline and simulated gastric fluid. The liquid viscosity sensing signal as a function of shear rate for a sensor. Liquids: mucus (1:8 mucin-water ratio in weight) with PBS and mucus (1:8 mucin-water ratio in weight) with SGF. Error bars represent standard deviation for n=periods.

FIGS. 13A and 13B show an experimental setup for tracking robot and viscosity sensor using X-ray medical imaging. FIG. 13A is an illustration of the experimental setup for testing robot locomotion and sensor delivery with the guidance of an X-ray cabinet medical imaging machine (Faxitron MX-20). The porcine colon tissue is placed inside a phantom tube made of Ecoflex-0030 of which the inner diameter, outer diameter and length are 2 cm, 2.4 cm, and 5 cm, respectively. The robot is controlled by a permanent magnet-based magnetic actuation system (magnet size: 25 mm by 25 mm by 25 mm, NdFeB, N42). FIG. 13B is a zoomed-in image of a soft climbing robot and a viscosity sensor controlled by an external magnetic field in the phantom. Scale bar, 5 mm.

FIG. 14 shows a leaching test of the silica coated and uncoated NdFeB particles. The NdFeB particles were coated with silicon dioxide (silica). 8 g of NdFeB particles was first dispersed and stirred in 200 ml of ethanol. Then, 12 ml of 29% ammonium hydroxide (Aldon corporation, USA) and 0.4 ml of TEOS (Sigma-Aldrich Inc.) were slowly added into the mixture. The mixture was stirred at room temperature for 12 hours. After reaction, the particles were filtered, washed with acetone for three times and dried. 0.5 g of coated and uncoated NdFeB particles were respectively added to 7.5 ml HCl (pH=3.6). After 2 days, the uncoated particles were oxidized and the solution turned yellow, while there is no change observed for silica-coated particles.

FIGS. 15A-15D show example magnetic actuation systems. FIG. 15A is an illustration of the electromagnet system and the experimental setup for controlling the robot locomotion. FIG. 15B is an image of a soft robot carrying a magnetic viscosity sensor. Scale bar, 2 mm. FIG. 15C is an illustration of the magnetic actuation system with a permanent magnet. FIG. 15D is an image of a magnetic viscosity sensor on the porcine colon tissue. Scale bar, 2 mm.

FIG. 16 is a table of the parameters of the soft climbing robot and the magnetic viscosity sensor.

### DETAILED DESCRIPTION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, biology, biomedical engineering, and mechanical engineering techniques and the like, which are within the skill of the art. Such techniques are explained fully in the literature.

The following examples are put forth to provide those of ordinary skill in the art with a complete disclosure and description of how to perform the methods and use the compositions and compounds disclosed and claimed herein. Efforts have been made to ensure accuracy with respect to numbers (e.g., amounts, measurements, etc.), but some errors and deviations should be accounted for.

Before the embodiments of the present disclosure are described in detail, it is to be understood that, unless otherwise indicated, the present disclosure is not limited to particular materials, machines, computing processes, or the like, as such can vary. It is also to be understood that the terminology used herein is for purposes of describing particular embodiments only and is not intended to be limiting. It is also possible in the present disclosure that steps can be executed in different sequence where this is logically possible.

All publications and patents cited in this specification are cited to disclose and describe the methods and/or materials in connection with which the publications are cited. Publications and patents that are incorporated by reference, where noted, are incorporated by reference as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. Any terms not specifically defined within the instant application, including terms of art, are interpreted as would be understood by one of ordinary skill in the relevant art; thus, is not intended for any such terms to be defined by a lexicographical definition in any cited art, whether or not incorporated by reference herein, including but not limited to, published patents and patent applications. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

It should be noted that ratios, amounts, and other numerical data can be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to about 5%” should be interpreted to include not only the explicitly recited values of about 0.1% to about 5%, but also include individual values (e.g., 1%, 2%, 3%, and 4%) and the sub-ranges (e.g., 0.5%, 1.1%, 2.2%, 3.3%, and 4.4%) within the indicated range. Where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In some embodiments, the term “about” can include traditional rounding according to significant figures of the numerical value. In addition, the phrase “about ‘x’ to ‘y’”, where ‘x’ and ‘y’ are numerical values, includes “about ‘x’ to about ‘y’”.

### DISCUSSION

Disclosed are various approaches for the design, delivery, and control of viscosity sensors and delivery mechanisms thereof. While the Example herein is focused on the design, delivery, and control of viscosity sensors to a location in a GI tract, the principles of the present disclosure can also be extended to various other sensors, locations, or uses as can be appreciated. The approaches disclosed herein provide a new way of measuring the physiological properties of soft tissues in situ to facilitate understanding of disease development and provide long-term diagnostic function.

Accordingly, various embodiments of the present disclosure are directed to systems and methods for measuring the physiological properties of soft tissues in situ by wireless miniature sensors actuated by magnetic fields and tracked by medical imaging. These miniature viscosity sensors can be delivered via a minimally invasive technique using a novel sensor delivery mechanism. Each sensor can be delivered by use of a magnetically actuated soft robot. By using a soft climbing robot, the sensor can be carried through confined and narrow spaces and be reliably deployed on soft tissue surfaces. In some applications, multiple sensors could be delivered on soft biological tissues to sense various mechanical properties near the soft tissue spatiotemporally.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principles disclosed by the following illustrative examples.

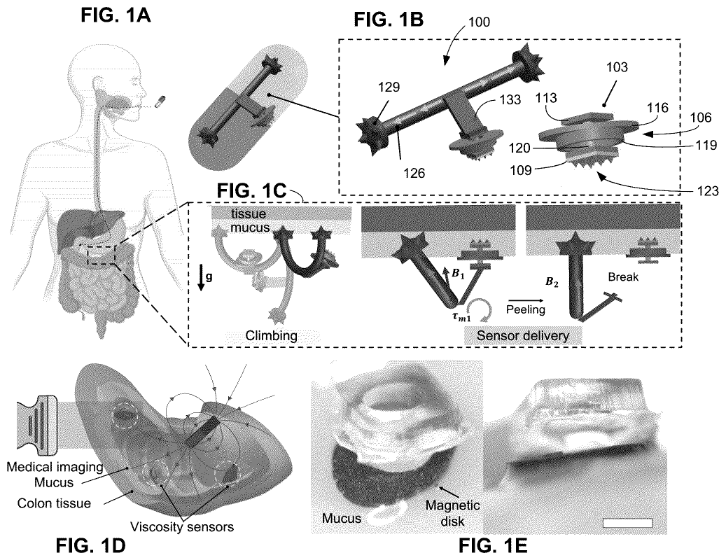

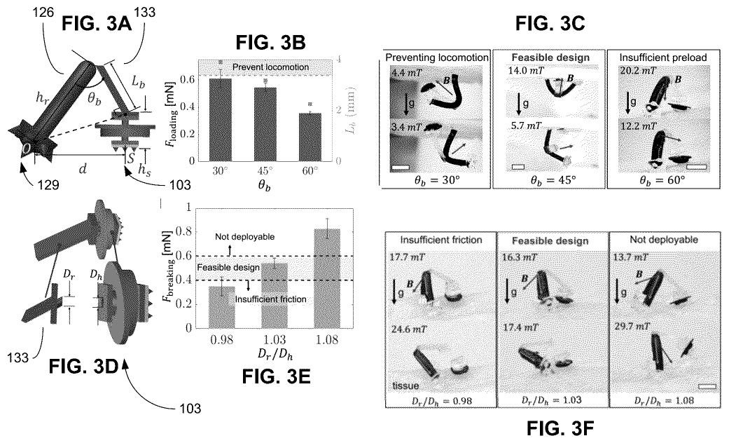

With reference to FIG. 1, shown is an illustration of soft robot 100 enabled delivery of sensors 103 for in situ sensing of mucus viscosity. As shown in FIGS. 1A and 1B, the process can begin with ingestion of a capsule containing the soft robot 100 and the miniature sensor 103 to be delivered. In some embodiments, the soft robot 100 and the sensor 103 can be transported to the GI tract by another means. In FIG. 3B, greater detail of the soft robot 100 and sensor 103 are illustrated. The sensor 103 can include a variety of different components in order to facilitate delivery by the soft robot 100, adhesion to a mucosal layer in the GI tract, and sensing of the mucosal properties within the GI tract. For example, the sensor 103 can include a rotating magnetic spinner 106, a foot 109, and a cap 113.

The rotating magnetic spinner 106 can be rotated when acted upon by a magnetic field. The rate of rotation of the rotating magnetic spinner 106 can be detected by medical imaging and calculations can be performed based at least in part on the rate of rotation and the applied magnetic field to determine the viscosity of the mucosal layer surrounding the sensor 103. The rotating magnetic spinner 106 can include a magnetic disk 116 and a magnetic ring 119. In some embodiments, the magnetic disk 116 can be an elliptical shaped disk. For example, the magnetic disk 116 can have a long diameter of approximately 2-3 mm and a short diameter of 1-2 mm. In some embodiments, the magnetic disk 116 can be formed in another oblong shape which can be easily tracked by medical imaging. The magnetic disk can be disposed on top of a magnetic ring 119. In some embodiments, the magnetic ring 119 is disposed about a central shaft 120 of the sensor 103 and configured to spin about the shaft 120. In some embodiments, the magnetic ring 119 can have an inner diameter of 1-1.5 mm and an outer diameter of 1.5-2 mm. The rotating magnetic spinner 106 and its components can be formed from Polydimethylsiloxane (PDMS) and NdFeB particles. In some embodiments, the rotating magnetic spinner 106 can formed from PDMS and NdFeB particles in a 1:2 ratio by weight. In some embodiments, the rotating magnetic spinner 106 can have a programmed magnetization profile such that when a rotating magnetic field is applied to the rotating magnetic spinner 106, the rotating magnetic spinner 106 commences rotation.

The sensor 103 can further comprise a foot 109. The foot 109 can serve as the anchor of the sensor 103 by sticking into the mucosal layer at the designated delivery location within the soft tissue. In some embodiments, as shown in FIG. 1B, the foot 109 is square in shape. However, the foot 109 could comprise a number of other shapes having a large surface area to help the foot 109 stick in the mucosal layer. The foot 109 can include a plurality of microstructures 123 such as, for example, microspikes. The plurality of microstructures 123 can further increase the surface area of the foot 109 to improve adhesion to the mucosal layer. In some embodiments, to further enhance adhesion of the foot 109 to the mucosal layer, the foot 109 can be coated with hydrogel and/or an applied bioadhesive, such as a chitosan-based bioadhesive.

In some embodiments, the sensor 103 further includes a cap 113. The cap 113 can be disposed at an end of the shaft 120 and configured to connect the sensor 103 to the soft robot 100 for delivery and transportation purposes. In some embodiments, the cap 113 includes a hole, a push-snap, an adhesive, or another connection means which can release once the sensor 103 has been placed. While depicted as having a square shape in FIG. 1, the cap 113 can be any shape which is compatible with the delivery mechanism included on the soft robot 100. In some embodiments, the cap 113 is formed from PDMS.

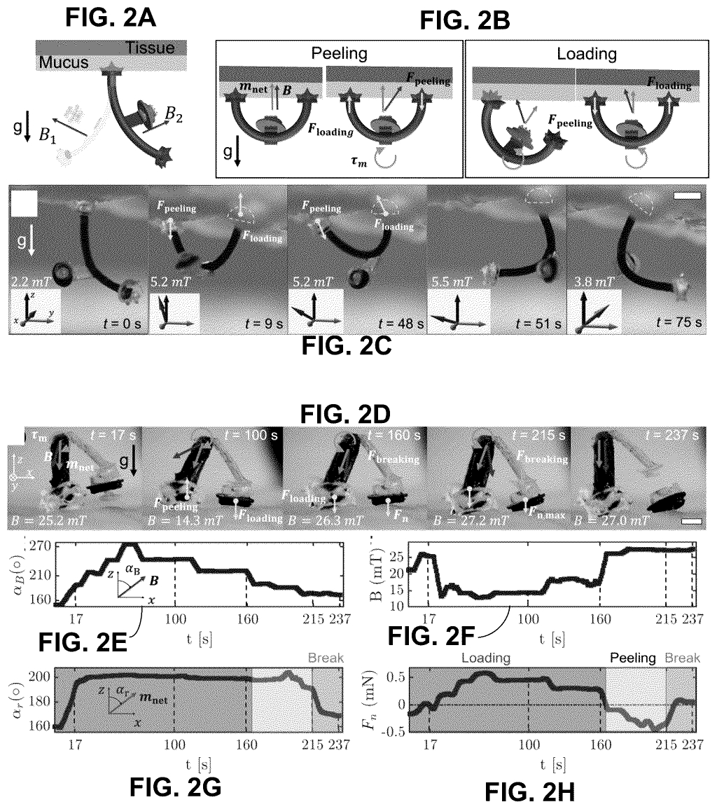

Moving now to FIG. 2, shown is an example mechanism and operation of the soft robot 100. The soft robot 100 can be representative of a small-scale soft climbing robot having a robot body 126, a plurality of footpads 129, and a delivery member 133. The soft robot 100 can be a magnetically actuated tumble-motion robot which is capable of end-over-end mobility when acted upon by a rotating magnetic field. In some embodiments, the robot body 126 is a magnetic robot body. For example, in some examples, the robot body 126 is formed from a mixture of silicone rubber, silicone gel, and NdFeB microparticles in a 3:1:8 ratio by weight. The robot body 126 can have a programmed magnetization profile such that when a rotating magnetic field is applied to the robot body 126, the robot body 126 performs the end-over-end tumbling motion. According to various examples, the robot body 126 can comprise a shaft having a first end with a first footpad 129 and a second end with a second footpad 129. The robot body 126 can be formed in the shape a cylindrical shaft, a rectangular beam, or another balanced and elongated shape. In some embodiments, the robot body 126 has a diameter of about 700-800 μm and a length of about 6-10 mm.

The plurality of footpads 129 can be representative of the number of footpads 129 which corresponds to the number of ends of the robot body 126. For example, if the robot body 126 had one cylindrical shaft, there would be at least two footpads 129 with one footpad 129 corresponding to each end of the cylindrical shaft. In some embodiments, the robot body 126 can include two or more shafts connected together, such that more than two footpads 129 are required to correspond to the number of ends. In some embodiments, the footpads 129 have a half-spherical shape. However, the footpads 129 can also have a cubical shape, a conical shape, or another shape having a large surface area on the distal end. In some embodiments, the footpads 129 are formed from PDMS, or another silicone-like biocompatible material. Similar to the foot 109 of the sensor 103, the footpads 129 of the soft robot 100 can include a plurality of microstructures on the distal surface of each footpad 129 in order to increase the surface area of each footpad 129 and thereby increase the grip. In some embodiments, the plurality of microstructures on each footpad 129 are microspikes. The plurality of footpads 129 can further include a hydrogel coating and/or an adhesive coating to further enhance the grip that each footpad 129 can have to the mucosal layer of soft tissues. The hydrogel can comprise a mixture of polyethylene glycol diacrylate (PEGDA). In some embodiments, the adhesive can comprise a chitosan-based bioadhesive.

Next, at FIG. 3, shown is an example design of the sensor 103 delivery mechanism. The soft robot 100 includes a delivery member 133 which can be representative of the mechanism for carrying and delivering the sensor 103 to the desired location within the soft tissue. As shown in FIG. 3A, the delivery member 133 can comprise a cantilever beam which is anchored on one end to the robot body 126. In some embodiments, the delivery member 133 is connected to the robot body 126 near the middle of the robot body 126. In some embodiments, the delivery member 133 is connected to the robot body 126 as a cantilever beam on a revolute joint. The delivery member 133 can further include a connector rod at a distal end from the connection to the robot body 126. The connector rod can be configured to mate with a reciprocal hole in the cap 113 of the sensor 103. In some embodiments, the delivery member 133 includes a different means of connecting to the sensor 103 such as a push-snap, an adhesive, or another mechanism. The delivery beam can be made form PDMS, silicone, or another biocompatible material.

Finally, the soft robot 100 and the sensor 103 each can be operated using a magnetic actuator. The magnetic actuator can produce a rotating magnetic field which can be used to manipulate the soft robot 100 and the sensor 103. The magnetic actuator can be representative of any device, system, or component, which is capable of producing a rotating magnetic field. The magnetic actuator can be an electromagnetic actuation system, a mobile permanent magnet system, a Halbach array made of a number of magnets, or another form of magnetic actuator. In some embodiments, the electromagnetic actuation system can comprise six solenoids in a half-spherical configuration, each solenoid driven by a direct current (DC) motor. In some embodiments, a magnet rotated by a motor can be used as a magnetic actuator to generate a rotating magnetic field having a controlled frequency and magnitude.

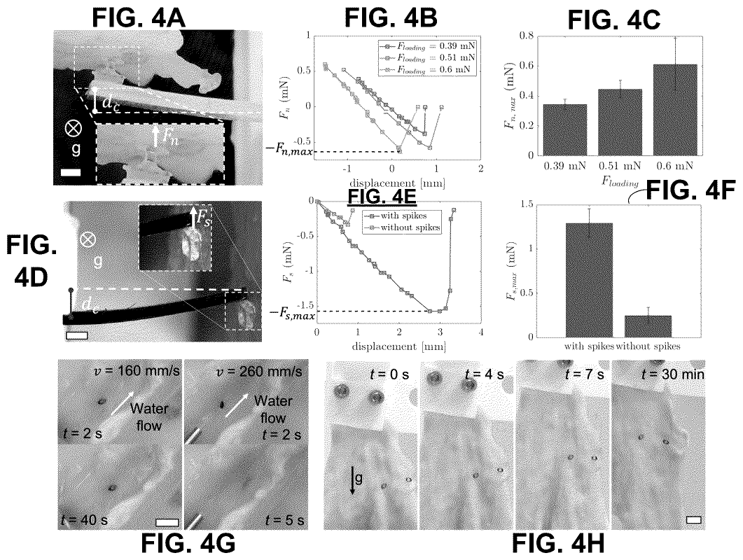

Moving next to FIG. 4, shown is a characterization of the anchoring force on porcine colon tissues. Through the use of magnetic torque, the soft robot 100 can be manipulated within a body to climb soft tissues and to place the sensor 103 on those soft tissues. By using adhesives and microstructures on the foot 109 and footpads 129 of the sensor 103 and soft robot 100 respectively, the anchoring force of the sensor 103 and soft robot 100 can be substantially increased compared to when these elements are not present. Once placed, the sensor 103 can remain in place for up to several hours, withstanding the stretching and compression of the soft tissues as well as flow of various fluids past the sensor 103 while it is anchored.

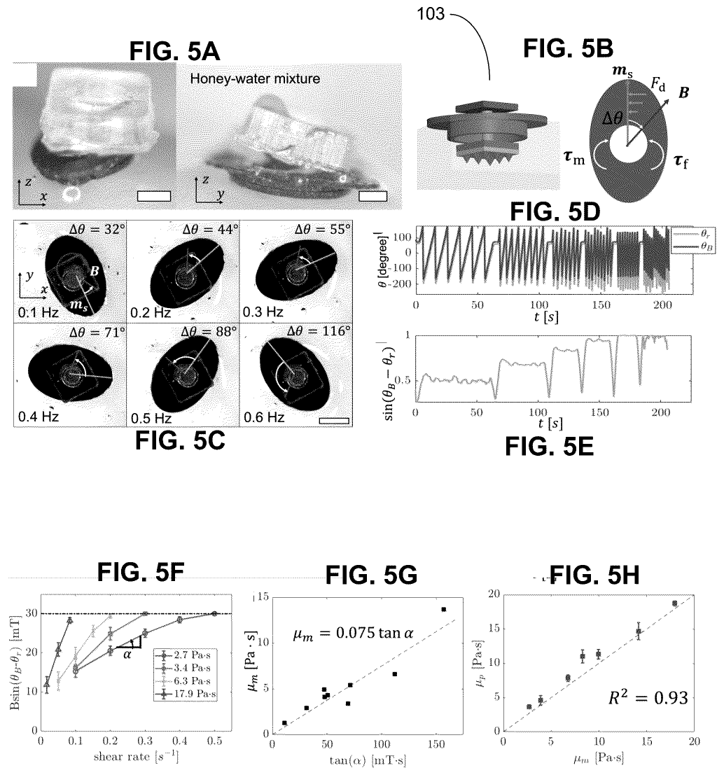

Next, at FIG. 5, shown is a characterization of the operation of the sensor 103. Once the sensor 103 has been placed and the soft robot 100 has been removed, the sensor 103 can be activated by applying a rotating magnetic field. The rotating magnetic spinner 106 will contact the mucosal layer when the sensor 103 is in place. By applying a known magnetic field and observing the rate at which the magnetic spinner 106 rotates through the mucosal layer, the viscosity of the mucosal layer can be derived (as described in Example A).

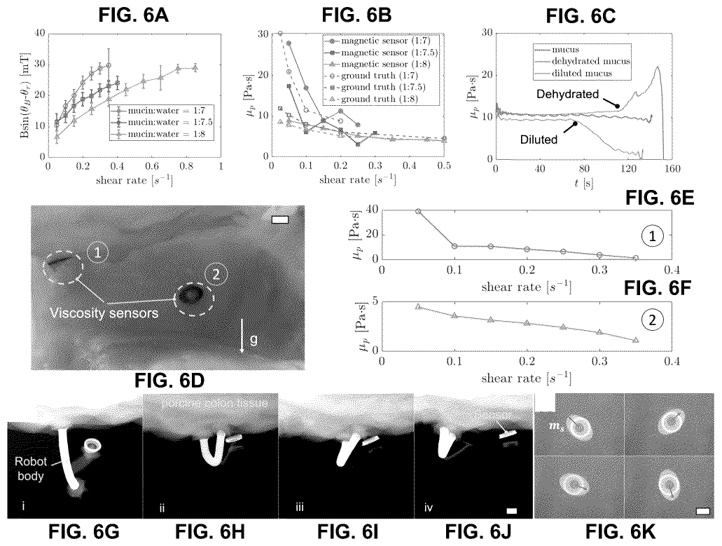

Moving now to FIG. 6, shown is an example of sensing mucus viscosity in situ. By using medical imaging, such as X-ray, computed tomography (CT), positron emission tomography (PET), ultrasound, or other medical imaging, the rotation of the magnetic spinner 106 of the sensor 103 can be observed and tracked. In some embodiments, multiple sensors 103 can be placed at different locations across soft tissues to develop a sensor network. In this way, a more wholistic reading of the mucus viscosity can be determined.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

### Example A

### INTRODUCTION

Constructing a sensor network on soft biological tissues could help continuously monitor physiological properties of soft tissues in situ, facilitate the understanding of disease development, and provide a long-term diagnosis function. The human gastrointestinal (GI) and respiratory tracts are covered with mucus which is a complex biological fluid that lubricates and protects the mucosa layer. Mucus has a viscosity ranging from 100 to 10,000 times the viscosity of water, which is an important biomarker for monitoring human physiological properties and early disease diagnosis. Particularly in the GI tract, compared with that in healthy people, mucus viscosity is evidently different for patients with peptic ulcer, inflammatory bowel disease (IBD) and unbalanced gut microbes. Mucus viscosity will also increase when viscous and thick mucus is built up for patients with cystic fibrosis due to genetic problems. Monitoring mucus viscosity continuously could help understand the development of disease and help identify efficient point-of-care treatment methods by providing frequent feedback information.

However, it is challenging to measure mucus viscosity using existing medical imaging modality and medical tools. GI tract endoscope-based procedures such as endoscopic retrograde cholangiopancreatography (ERCP) or colonoscopy cannot access the small intestine and upper colon easily and can potentially cause trauma and other complications for patients under anesthesia. In addition, passive capsule devices and active capsule endoscope robots have been developed to collect and sense biofluids in the GI tract, which are typically at the centimeter scale and can only access the space with comparable size of the capsule in the GI tract. Moreover, further in vitro testing of the properties of the collected mucus sample using fluorescence microscopes and other tools may not accurately reflect the mucus properties as they depend on the humidity and temperature. Therefore, wireless sensors delivered with minimal invasion that can sense mucus properties in situ are demanded for continuously sensing mucus viscosity for disease monitoring and diagnosis. However, such miniature wireless sensors are currently missing, and the method to deliver these sensors onto mucus-covered soft tissues deep inside the body is also limited.

To tackle this challenge, a method to sense mucus viscosity in situ is proposed which is enabled by wireless miniature viscosity sensors actuated by magnetic fields and tracked by medical imaging. Also proposed is a novel delivery mechanism for the miniature sensors by controlling millimeter-scale soft climbing robots. First, the delivery mechanism is presented by introducing the design, fabrication, and control of a miniature soft robot for climbing soft biological tissues with agile maneuverability. Second, the delivery of a viscosity sensor by the soft robot on soft biological tissues covered with mucus is explained. Moreover, the design and characterization of the magnetically actuated viscosity sensor is shown for sensing liquid viscosity in synthetic fluids enabled by the fluid-structure interaction. Finally, controlling the soft robot to deliver multiple viscosity sensors is demonstrated on porcine colon tissues ex vivo to sense mucus viscosities spatiotemporally. The proposed minimally invasive robotic delivery mechanism and viscosity sensing devices could potentially allow sensing biofluid properties deep inside the body with minimal invasion for disease monitoring and diagnosis functions in the future.

### 1. Concept of In Situ Viscosity Sensing Enabled by Soft Miniature Robots

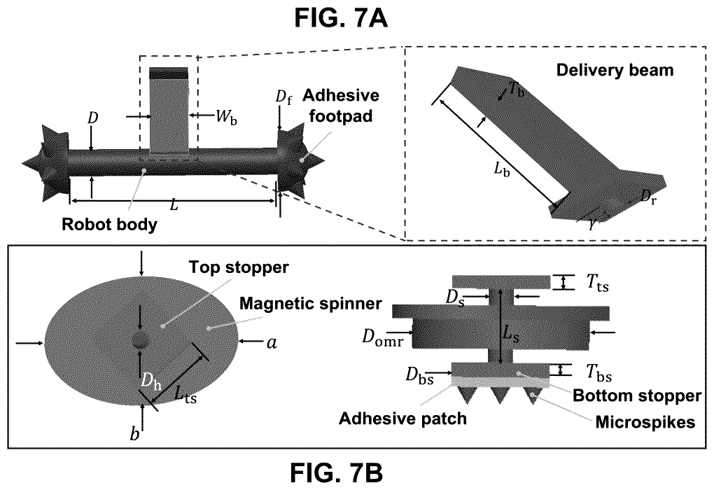

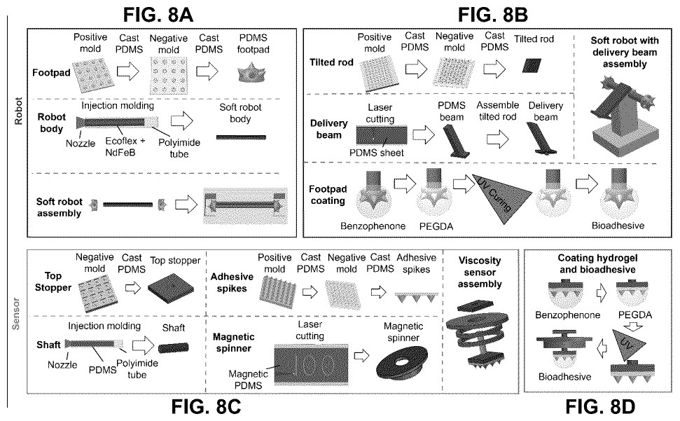

FIGS. 1A-1E shows the concept of the wirelessly actuated viscosity sensor for sensing mucus viscosity in the GI tract and its delivery mechanism by a soft climbing robot capable of navigating on soft tissues. The soft climbing robot carrying a viscosity sensor can be encapsulated in an ingestible capsule to reach the deep area of the GI tract such as the large intestine as shown in FIG. 1A. When the robot is released from the capsule after dissolving, it could be further controlled by external magnetic fields to navigate to a targeted position to deploy the viscosity sensor. FIG. 1B illustrates the viscosity sensor and the soft climbing robot which has a rod-shaped magnetic body with a specific magnetization profile, two adhesive footpads, and a mechanical structure for delivering the viscosity sensor (see FIG. 7). The robot and sensor are manufactured by combining laser machining and micro-molding (see FIG. 8, and the “Materials and Methods” for more details). The viscosity sensor has a magnetic spinner that rotates about a shaft, and an adhesive patch with microspikes for anchoring on mucus-covered soft tissues which will be discussed in Section 4 “Mechanism of Wirelessly Sensing Liquid Viscosity”.

The soft climbing robot can climb a soft and wet tissue surface by a previously reported peeling-and-loading mechanism and a chitosan-based bioadhesive coated on the robot footpads for adhering to the mucus layer. The robot exhibits agile maneuverability by controlling the external magnetic fields (see Section 2 “Robot Locomotion and Sensor Delivery on Mucus-Covered Tissues”). FIG. 1C shows that the soft robot can reach the targeted position through the climbing motion and the viscosity sensor can be deployed and anchored onto mucus-covered tissue surfaces by controlling a delivery beam on the soft robot, which allows the sensor to be pushed onto soft tissues and detach from the delivery beam due to a breaking mechanism. Moreover, medical imaging modalities such as X-ray imaging can be used to guide the navigation of the soft climbing robot and track the magnetic spinner for sensing mucus viscosity as shown in FIG. 1D. Multiple sensors can be deployed sequentially by the miniature soft climbing robots to build a sensor network on the soft tissues. Each sensor can work individually when actuated by a rotating magnetic field so that the sensor can be used for monitoring mucus viscosity spatiotemporally such as the viscosity sensor anchored on a porcine colon tissue in FIG. 1E.

### 2. Robot Locomotion and Sensor Delivery on Mucus-Covered Biological Tissues

The robot locomotion mechanism on mucus-covered tissues is shown for the rod-shaped soft robot when carrying a cantilever delivery beam in FIG. 2. FIG. 2A shows that the robot can bend in arbitrary directions when actuated by a 3D external magnetic field B after one robot footpad adheres to the tissue surface due to bioadhesion. The robot climbing locomotion is enabled by the previously reported peeling-and-loading mechanism. As shown in FIG. 2B, when peeling a footpad from the tissue, a magnetic torque in the plane of the robot body is generated on the robot body by rotating the external magnetic field. The magnetic torque further induces a force couple applied on the robot footpads. By increasing the magnetic torque, the peeling force of the detaching footpad will be greater than the anchoring force leading to the detachment. When loading a footpad, an opposing magnetic torque generated by rotating the magnetic field is applied to make the robot bend towards the tissue surface. The magnetic torque also produces the loading force required to adhere on the tissue surface. FIG. 2C show the control of the inverted climbing process of the soft robot on porcine colon tissues. When one robot footpad adheres to the soft tissue, the other robot footpad is free at the beginning (t=0 s). The unanchored footpad is loaded on the tissue surface by rotating the external magnetic field (t=9 s). Then, the other footpad is peeled off from the tissue surface (t=48 s). After the peeling process, the robot still has one footpad adhering to the tissue and can be again steered to the targeted directions by controlling the angle of the external magnetic field (t=51 s and t=75 s).

To illustrate the sensor delivery mechanism, in FIGS. 2D-H, the sensor delivery mechanism and estimation of the peeling and loading forces generated by the net magnetic torque is shown. Before the sensor deployment, the robot first moves to the targeted position and loads its two footpads on the tissue surface. As shown in FIG. 2D, a magnetic torque is applied to load the sensor on the mucus layer by rotating the magnetic field out of the robot plane at t=17 s. After the sensor contacts the tissue surface, the magnetic torque induces a peeling force on the robot footpads and a loading force on the viscosity sensor. After applying the loading force for 60 seconds to ensure sufficient tissue adhesion, an opposing magnetic torque is exerted to induce a breaking force between the viscosity sensor and the delivery beam (t=160 s). When further rotating the magnetic field, the pulling force applied to the delivery beam increases and becomes sufficient to overcome the friction between the rod and the hole. The viscosity sensor starts to slide and is detached from the delivery beam (t=215 s). The viscosity sensor remains on the tissue surface due to the strong bioadhesion from the mucus layer (t=237 s). In FIGS. 2E and 2F, the magnetic field waveform is shown, including the magnitude B and angle α_{B} in the delivery process, respectively. At the same time, the robot body angle is extracted from the optical images to further analyze the applied magnetic torque, as well as the induced surface adhesion and supporting force on the robot footpads and sensor adhesive patch. Assuming only rigid-body rotation, based on the moment balancing condition of the robot and sensor, the adhesion and supporting force are given by,

$${F}_{a} = {F}_{n} = \frac{{τ}_{m}}{d} \qquad ( 1 )$$

where d is the distance between the midpoint of the two robot footpads and the sensor adhesive patch, and τₘ is the magnetic torque given by τₘ=|mₙₑₜ×B|=mₙₑₜBsin(α_{B}−αᵣ). Here αᵣ is the tracked robot body angle as shown in FIG. 2G, and mₙₑₜ is the net magnetic moment of the robot body which is obtained by tracking the robot deformed body shape and a known magnetization profile. FIG. 2H shows the estimated time-varying adhesion where the negative peak value (−0.5 mN) indicates the breaking force required for sensor delivery. During this process, the adhesion on the sensor patch should be larger than this peak force to prevent the detachment of the sensor from the tissue surface.

To optimize the sensor anchoring force and robot maneuverability, the design of the robot delivery beam is investigated for maximizing the sensor-tissue adhesion. The loading force Fₙ should be maximized as the adhesion between the viscosity sensor and the tissue is stronger with a larger loading force. Equation 1 indicates that the distance d needs to be minimized for greater loading force as shown in FIG. 3A. With a given Ob and the robot height hᵣ when deformed, the minimum d is determined by dₘᵢₙ²=(hᵣ sinθ_{b})²−hₛ² here hₛ is the height of the sensor and hᵣ is the assumed height of the deformed robot body under 20 mT. Meanwhile, it is desirable to minimize L_{b} so that the delivery beam does not interfere with the robot climbing locomotion. To explore the feasible θ. for the sensor delivery, values of 30°, 45°, and 60° were chosen to quantify the maximum loading force and corresponding beam length for different θ_{b} in FIG. 3B. If the delivery beam is too long as shown in FIG. 3C (θ_{b}=30°), the viscosity sensor may unintentionally touch the tissue when moving to a targeted location. Therefore, the maximum beam length is set to 0.75 hᵣ to ensure the locomotion is not affected. When θ_{b}=60°, the loading force is not able to generate enough adhesion for the sensor deployment; the maximum adhesion force is smaller than the breaking force so that the sensor will be detached from the tissue surface before breaking. When θ_{b}=45°, the generated adhesion is sufficient for sensor deployment and the robot locomotion is not influenced.

Then, the design of the rod-hole connection is investigated for controllable sensor loading and deployment. FIG. 3D shows another design parameter—the ratio between the rod diameter Dᵣ and hole diameter Dₕ. The ratio Dᵣ/Dₕ determines the required breaking force for sensor deployment and should be within a range that allows controllable detachment without unintentional drop-off during climbing. FIGS. 3E and 3F show the breaking force for different Dᵣ/Dₕ where Dᵣ is 0.59 mm, 0.62 mm, and 0.65 mm while Dₕ is fixed to be 0.6 mm. FIG. 3E shows that when Dᵣ/Dₕ=0.98, the friction is insufficient so that the sensor may accidentally drop off before being loaded on the tissue. A minimum breaking force about 0.4 mN is needed to avoid unplanned deployment. With Dᵣ/Dₕ=1.08, the friction is larger than the maximum breaking force or the maximum normal adhesion force between the sensor and mucus, making it unable to deploy the sensor. Thus, the maximum required breaking force is set to 0.6 mN. Finally, when Dᵣ/Dₕ=1.03, the breaking force is enough to ensure controllable deployment as shown in FIG. 3F.

### 3. Characterization of the Sensor Anchoring 1 Force on Soft Biological Tissues

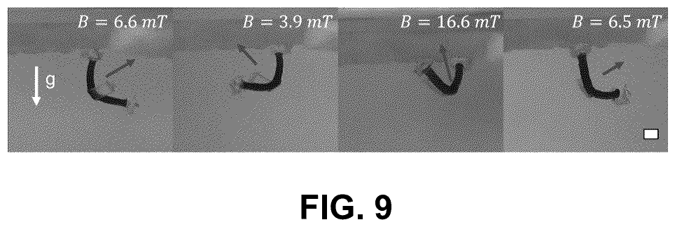

To further investigate the retention of the sensor on soft tissues, the anchoring force of the sensor is quantified on porcine colon tissues using a cantilever beam (FIG. 9) based on the Euler-Bernoulli beam theory in FIG. 4. First, the normal anchoring force is quantified in FIGS. 4A-4C. FIG. 4A shows that a sensor probe attached to the tip of the cantilever beam is loaded on the porcine tissue, of which the displacement and the normal anchoring force calculated from the beam deflection dₑ in the detachment process are plotted in FIG. 4B. A preload of 0.39 mN, 0.51 mN, and 0.6 mN respectively is applied to the sensor using the cantilever beam, which are the maximum loading forces for robots with different θ_{b} assuming the same applied maximum magnetic torque. FIG. 4C shows the maximum normal anchoring forces, where loading forces of 0.51 mN and 0.6 mN yield normal adhesion on the sensor patch that are larger than the breaking force thus allowing for sensor deployment. In contrast, a loading force of 0.39 mN cannot provide sufficient adhesion to the sensor patch which causes the sensor patch to detach from the tissue surface before the sensor is deployed. Moreover, in FIGS. 4D-4G, the shear anchoring force are quantified when the cantilever beam exerts tangential forces to the sensor. FIG. 4D shows that the sensor is first loaded onto the tissue surface by normal forces, and then a tangential force is applied on one side of the sensor patch by moving the cantilever beam. A force-displacement curve is plotted in FIG. 4E, which shows that the sensor patch starts to slide on the tissue surface when the tangential force exceeds the maximum shear force. The maximum shear force for sensor patches with and without microspikes is compared in FIG. 4G; the patch with spikes has a shear retention force of 1.3 mN that is significantly larger than the 0.2 mN the patch without spikes provides. The shear retention force is greater because the spikes can penetrate the mucus layer and enable the chitosan to form stronger bonds with the mucus layer. Lastly, the robustness of the sensor anchoring mechanism on soft tissues is investigated when subject to external disturbances. FIG. 4G demonstrates that the sensor can withstand a water flow up to 160 mm/s before being flushed away which is greater than the maximum flow rate in the GI tract (76 mm/s). Meanwhile, FIG. 4H shows that the viscosity sensor remains on the porcine colon tissues when the colon tissue is exposed to cyclic loading at a frequency of 0.05 Hz, which is close to the peristaltic motion of the GI tract, through stretching and compressing the tissue by a mechanical tester. These tests show the potential for the viscosity sensor to remain anchored on colon tissues for monitoring mucus properties despite unintentional and periodic disturbances.

### 4. Mechanism of Wirelessly Sensing Liquid Viscosity In Situ

In FIG. 5, the mechanism of viscosity sensing is presented by showing the theoretical derivation, calibration method, and sensing process of the viscosity sensor. After the sensor anchors on the mucus layer, the magnetic spinner will contact the mucus layer as shown in FIG. 5A. The magnetic spinner, which is composed of a magnetic ring and a magnetic disk, is wetted by the mucus with the help of capillary force. FIG. 5B illustrates the viscosity sensing mechanism when a rotating external magnetic field is applied in the plane of the tissue surface. The moment balance equation of the magnetic spinner is given by

$${τ}_{m}^{s} = {τ}_{d} + {τ}_{f} \qquad ( 2 )$$

where τₘ, τ_{d}, τ_{f} are the torques from magnetic fields, fluid drag, and other friction forces. The magnetic torque magnitude is given by τₘ^{s}=mₛBsin(θ_{B}−θᵣ), where mₛ, B, Δθ=θ_{B}−θᵣ are the magnetic moment of the spinner, the external magnetic field, and the angle difference between B and mₛ, respectively. Meanwhile, assuming τ_{d} is linearly proportional to the spinner rotating frequency with no step-out, we have τ_{d}=K_{A}μ_{f}f_{B} where K_{A}, μ_{f}, f_{B} are the coefficient of the fluid drag, the viscosity of the liquid, and the magnetic field frequency, respectively. By substituting τ_{d} and τₘ^{s} in Equation 2, the following is achieved:

$$B sin Δθ = \frac{{K}_{A} {μ}_{f}}{{m}_{s}} {f}_{B} + \frac{{τ}_{f}}{{m}_{s}} \qquad ( 3 )$$

In the sensing process, Δ θ=θ_{B}−θᵣ could be estimated via imaging. The coefficient of the fluid drag K_{A} is assumed to be a constant dependent on the geometry of the magnetic spinner. The average friction-induced torque τ_{f} is assumed to be constant each period. Therefore, the liquid viscosity at different shear rates can be determined by quantifying the slope angle when plotting BsinΔθ as a function of shear rate when K_{A}/mₛ and τ_{f}/mₛ are known after calibration.

The calibration and validation of the viscosity sensor are further shown in FIGS. 5C-5H. K_{A}/m is calibrated for every viscosity sensor with a magnetic spinner by placing the viscosity sensor in either glycerol or a honey-water mixture with known viscosities on a plastic substrate. The bottom surface of the magnetic spinner is fully wetted while the top remains above the liquid. A rotating magnetic field with a magnitude of 30 mT, generated by a permanent magnet, is applied to the spinner at different frequencies. Δθ is extracted from sequential optical images as shown in FIG. 5C. As the frequency increases, Δθ also increases as the required magnetic torque to overcome the fluid drag increases. After Δθ is larger than 90°, the spinner starts to step out, meaning the magnetic torque cannot keep the magnetic spinner rotating at the same frequency as shown in FIG. 5D and FIG. 5E. Further, BsinΔθ is plotted as a function of the shear rate; the shear rate increases until the magnetic spinner steps out as illustrated by the viscosity sensing curve in FIG. 5F for the same sensor in liquids with varying viscosities. To calibrate the sensor, nine different Newtonian liquids with different viscosities are used. The viscosities varying from 1.3 Pa·s to 13.7 Pa·s are measured by a viscometer (Bonvoisin Digital Rotary Viscometer). To get K_{A}/mₛ, the slopes of the viscosity sensing curves are extracted as shown in FIG. 5G. To verify the calibration result, predicted viscosities of another seven Newtonian liquids are compared with viscosities from 2.7 Pa·s to 17.9 Pa·s. FIG. 5H shows that the predicted viscosity agrees with the measured viscosity with a R value of 0.93.

### 5. Medical Imaging-Guided Mucus Viscosity Sensing and Robot Locomotion

In FIG. 6, the potential of the viscosity sensor to sense mucus viscosity in situ is demonstrated. First, porcine mucus is prepared by mixing porcine mucin and water; three different mucin-water ratios with different shear-rate dependent viscosities are prepared. The slopes of the viscosity sensing curves decrease as the shear rate increases in FIG. 6A; when using a shear rate from 0.05 s⁻¹ to 0.5 s⁻¹, the mucus displays shear-thinning behavior. Then, the calibration is used to predict the mucus viscosity of different mucin-water ratios at different shear rates as shown in FIG. 6B with relative accuracy.

The temporal sensing capabilities of the viscosity sensor are shown in FIG. 6C where the mucus viscosity is varied and monitored. The first experiment is conducted with mucus at a 1:7 mucin-water ratio in weight and constant shear rate of 0.15 s⁻¹, where the predicted viscosity stays constant. Further experiments are modified to increase or decrease the viscosity. To decrease the viscosity, the mucus is diluted, and the predicted viscosity shows a corresponding decrease. On the other hand, the viscosity is increased by dehydrating the mucus through heating at 90° C., and the predicted viscosity shows a corresponding increase. Equation 3 is used to calculate the viscosity, where τ_{f} is acquired from previous mucus viscosity sensing experiment and assumed to be constant in each period. The ability to temporally sense viscosity allows monitoring of physiological and pathophysiological conditions for disease diagnosis.

Moreover, to spatially sense viscosity, the potential in building a sensor network where multiple sensors are deployed at different locations is demonstrated as shown in FIGS. 6D-6F. As a proof-of-concept, two sensors are loaded on the top and vertical surfaces of a porcine tissue ex-vivo. Mucus with different viscosities are applied locally to where the viscosity sensors are loaded. By applying a rotating magnetic field sequentially in the sensor spinner plane, the local liquid viscosity could be sensed at specific locations as shown in FIGS. 6E and 6F.

Finally, the soft climbing robot and the viscosity sensor can be tracked and guided with medical imaging guidance in the GI tract as displayed in FIGS. 6G-6K. The locomotion and sensor deployment are demonstrated with the X-ray imaging as shown in FIGS. 6G-6J. The external magnetic field can be controlled to navigate the robot based on the feedback of the robot position and shape. Once the viscosity sensor is loaded on the mucus layer, a rotating magnetic field can be provided using a permanent magnet mounted on a step motor and the sensor can be tracked with medical imaging. The magnetic moment for the elliptical spinner is along its major axis and can be tracked using the X-ray imaging as shown in FIG. 6K.

### DISCUSSION

In summary, a delivery mechanism for wireless miniature sensors on mucus-covered tissue surfaces has been proposed by designing, fabricating, and controlling millimeter-scale soft climbing robots and magnetically actuated viscosity sensors based on fluid-structure interactions. It has been shown that a millimeter-scale soft climbing robot can be actuated by magnetic fields to have omnidirectional steering ability for climbing mucus-covered tissues and loading viscosity sensors on the soft tissues. The adhesive patch on the viscosity sensor allows for prolonged retention of the sensor on soft tissues for hours. The magnetic viscosity sensor, actuated by magnetic fields and tracked by medical imaging, has been shown to sense the viscosity of both synthetic Newtonian and non-Newtonian fluids. Finally, the soft robot can be controlled to deliver multiple viscosity sensors on the porcine colon tissues ex vivo to sense mucus viscosities spatiotemporally.

The retention time of the viscosity sensor on soft tissues is limited by the turn-over time of the mucus which is typically several hours. The retention time could be increased if integrated with mechanical anchoring mechanism such as a swelling hydrogel or heat-triggered gripper. In addition, the biocompatibility of the robot and sensors could be realized by coating a thin layer of PDMS or perylene. Nonetheless, the omnidirectional climbing ability of our soft climbing robot allows delivery of the viscosity sensors on locations that are challenging to reach in the GI tract, enabling targeted delivery of sensors precisely at different GI tract locations for building a sensor network by sequentially sending multiple soft climbing robots. Moreover, the magnetic actuation of the sensor and medical imaging-based motion tracking allow sensing at locations deep inside the body. In addition, although the delivery of viscosity sensors have been demonstrated in this work, the proposed sensor delivery mechanism could also be used for delivering other wireless sensors for sensing temperature, pH, and other physiological properties. The proposed method thus paves the way towards long-term, continuous monitoring and minimally invasive tracking physiological properties to help understand disease development and provide early diagnosis.

### Materials and Methods

Fabrication of the robot body. The 3D climbing soft robot capable of delivering viscosity sensors on soft biological tissues consists of a magnetic robot body, two half-spherical footpads, and a delivery beam. The robot body was made by injection molding. Ecoflex 00-30 silicone rubber (Smooth-On Inc.), Ecoflex gel silicone gel(Smooth-On Inc.), and NdFeB microparticles (average diameter, 5 μm; MQFP-15-7, Neo Magnequench) were mixed at a 3:1:8 ratio by weight and then poured into a syringe. The mixture was injected into a polyimide tube with an inner diameter of 740 μm and cured at room temperature. The cured mixture was cut into 8-mm long segments and extracted from the polyimide tube. The robot body was then attached to a piece of Scotch tape, folded into a U-shape, and magnetized in an impulse magnetizer (IM-10-30, ASC Scientific) with a 1.8 T magnetic field impulse.

Fabrication of the robot footpads. The robot footpads were made by transfer molding. First, positive molds for the half-spherical footpads were printed using clear resin (Formlabs, Inc) in a 3D resin printer (Form 3+, Formlabs, Inc.). After printing, the molds were cleaned in isopropyl alcohol in an ultrasonic cleaner for 20 minutes. Subsequently, the molds were exposed to ultraviolet (UV) light (wavelength: 365 nm) to cure. The positive molds were then coated with Trichloro(1 H,1 H,2H,2H-perfluorooctyl)silane (97%, Sigma-Aldrich, Inc.) by vacuum deposition. Then, negative molds were made with polydimethylsiloxane (PDMS, Dow Silicones Corporation) with a weight ratio of 10:1 between the monomer to the cross-linker (denoted as 10:1 PDMS in the following text) through casting the positive molds. The 10:1 PDMS was vacuumed and then cured on the hotplate at 90° C. for 1 hour. The negative molds were further coated with Trichloro(1H,1H,2H,2H-perfluorooctyl)silane. The 10:1 PDMS was cast into the negative mold and cured on a hotplate at 90° C. for 30 mins to obtain the half-spherical footpads. Two footpads were then glued on the robot body using uncured 10:1 PDMS with the assistance of a 3D-printed jig. Finally, the footpads were coated with Poly(ethylene glycol) Diacrylate (PEGDA) to enable the chitosan-based bio-adhesive to adhere to its surface. Benzophenone solution (20 wt % in ethyl alcohol, Sigma-Aldrich Inc.) was pipetted over the footpads as the hydrophobic photo-initiator. The mixture of PEGDA and deionized water at a 20% weight ratio combined with α-ketoglutaric acid (Chem-Impex Int'l. Inc.) at a 1% weight ratio was then 1 added on the footpads and cured using a UV lamp (365 nm) for 15 mins.

Fabrication of the sensor delivery structure. The delivery beam is composed of a long beam, a square sheet, and a tilted rod for connecting to the sensor, all made of 10:1 PDMS. To make the beam, a glass substrate was prepared with a 150-μm-thick spacer. 10:1 PDMS was poured onto the substrate and scraped with a razor blade. The scraped PDMS was then cured in an oven at 90° C. for 20 mins. The cured PDMS sheet was cut into rectangular beams of 1.2 mm in width and different lengths, as well as 1.2 mm by 1.2 mm by 120 μm square sheets using a laser machine (LPKF ProtoLaser U4, LPKF Laser & Electronics North America). To make the delivery beam stiff for ease of sensor deployment, uncured 10:1 PDMS was used to glue three thin PDMS beams together and cured with heat gun at 90° C. The square-shaped PDMS sheet was attached to the stacked PDMS beam at an angle of 60°. The tilted shaft was fabricated with the same transfer molding method used for fabricating the robot footpads. The tilting angle of 60° is designed to allow easy detachment of the sensor. The connecting rod has a length of 0.3 mm and a diameter varying from 0.56 mm to 0.66 mm. The cured tilting rod was further glued onto the square PDMS sheet. The delivery beam was then adhered to the robot body with a specific angle assisted by a 3D-printed jig.

Fabrication of the viscosity sensor. The viscosity sensor consists of a top stopper with a tilted hole, a PDMS shaft, a magnetic spinner, and a bottom adhesive patch with microspikes. As shown in FIG. 8, a negative mold for the square-shaped top stopper was printed using a 3D resin printer (Form 3+, Formlabs Inc.) and coated with Trichloro(1 H,1H,2H,2H-perfluorooctyl)silane. The length and thickness of the stopper and the depth of the hole were 1.5 mm, 0.5 mm, and 0.3 mm respectively. The 10:1 PDMS was cast on the negative mold and cured on the hotplate at 80° C. for 60 mins. The PDMS shaft was made by injection molding. The uncured 10:1 PDMS was poured into a syringe with 22 gauge needle whose inner diameter is 0.413 mm. Heat gun was used to cure the PDMS in the needle at 90° C. for 1 min. The cured shaft was then cut into segments with 0.5 mm in length using a razor blade. The bottom adhesive patch with microspikes was fabricated through the same transfer molding method used for making robot footpads. The positive mold with a 7-by-7 microspike matrix was printed by a 3D printer based on two-photon photolithography (Photonic Professional GT, NanoScribe). After casting and curing the 10:1 PDMS on the negative mold, the PDMS sheet with microspikes was cut into a disk of 1.1 mm in diameter with the LPKF U4 laser machine for integrating on the bottom adhesive patch. To make the magnetic spinner, 10:1 PDMS and NdFeB particles were mixed at a 1:2 ratio by weight and poured onto a glass substrate with a 150-μm-thick spacer. After being scraped and cured in an oven at 90° C. for 20 mins, the magnetic PDMS sheet was cut into ellipse shaped disks with the long diameter of 2.4 mm and the short diameter of 1.6 mm. Two laser-cut magnetic rings with an outer diameter of 1.6 mm and an inner diameter of 1.2 mm were glued to the elliptical magnetic disk using uncured 10:1 PDMS. The assembled magnetic spinner was then magnetized along the long-diameter axis in a 0.74 T magnetic field impulse using an impulse magnetizer (IM-10-30, ASC Scientific). The top stopper, the PDMS shaft, the magnetic spinner, and the bottom adhesive patch were glued together to make the viscosity sensor. The bottom adhesive patch with microspikes was then coated with hydrogel and applied bioadhesive.

Magnetic actuation. Two magnetic actuation systems were used in the experiments including an electromagnetic actuation system and a mobile permanent magnet system as shown in FIG. 9. The electromagnet system has six solenoids in a half-spherical configuration to allow a large workspace of 7 cm by 7 cm by 1.5 cm with a 95% uniformity and a magnetic field strength up to 20 mT. The solenoids were driven by six DC motor drivers (Syren 50, Dimension Engineering). The motor drivers were powered by six DC power supplies (24 V, 20 A). A PCI board (PCIe-6738, National Instrument) was integrated in a PC and controlled by LabVIEW 2020 via a joystick or by a preprogrammed signal generator. The magnetic field in the workspace was measured using a 3-axis magnetic field sensor (TLE493D, Infineon, AG). Two cameras (ELP 5-50 mm Varifocal Lens 1080P USB Camera) were connected to the same PC for visualizing and recording the experimental videos simultaneously. In addition, a separate customized setup with permanent magnets mounted on a set of step motors was also used to test the robot when a stronger magnetic field up to 30 mT is needed or in experiments in the X14 ray medical imaging cabinet. A permanent magnet was mounted on two stepper motors whose axes were perpendicular to each other. The magnet and step motors were further mounted on a linear motion stage controlled by another stepper motor. Two rotational step motors mounted on a linear motion stage were used to generate the desired magnetic field. The magnet mounted on the two step motors were controlled to control the magnetic field angle. The linear actuator allows moving the magnet to control the magnetic field magnitude.

Preparing bioadhesive. To integrate the bio-adhesive onto the footpads, a bridging polymer 21 chitosan (high molecular weight, Sigma-Aldrich Inc.) is dissolved into the compound 2-(N-morpholino) ethanesulfonic acid (MES) buffer (Sigma-Aldrich Inc.) at a weight ratio of 2.0%. 1 M NaOH was used to adjust the pH to about 6 at a volume ratio of 0.13%. Unsulfated N-hydroxysuccinimide (NHS 98%, Sigma-Aldrich Inc.) is used as a coupling reagent with a concentration of 12 mg/mL in the final solution.

Preparing porcine tissues, synthetic liquids, and mucus. The fresh porcine colon tissues were purchased from the local slaughterhouse, Tennessee, USA. The tissue was kept frozen in the freezer and defrosted before experiments. The porcine tissue was cut and attached to glass slides for testing. Pure glycerol, honey-water mixture, and synthetic mucus were used for experiments. Honey-water mixture was made by mixing honey and water at 100:1, 75:1, 50:1, and 25:1 ratios by volume, respectively. For the synthetic mucus, mucin from porcine stomach (Type II, 88%, Chem-impex International Inc.) was added into deionized water at 1:6, 1:7.5, 1:8 ratios by weight, respectively. The mixture was then stirred for 1 hour at room temperature.

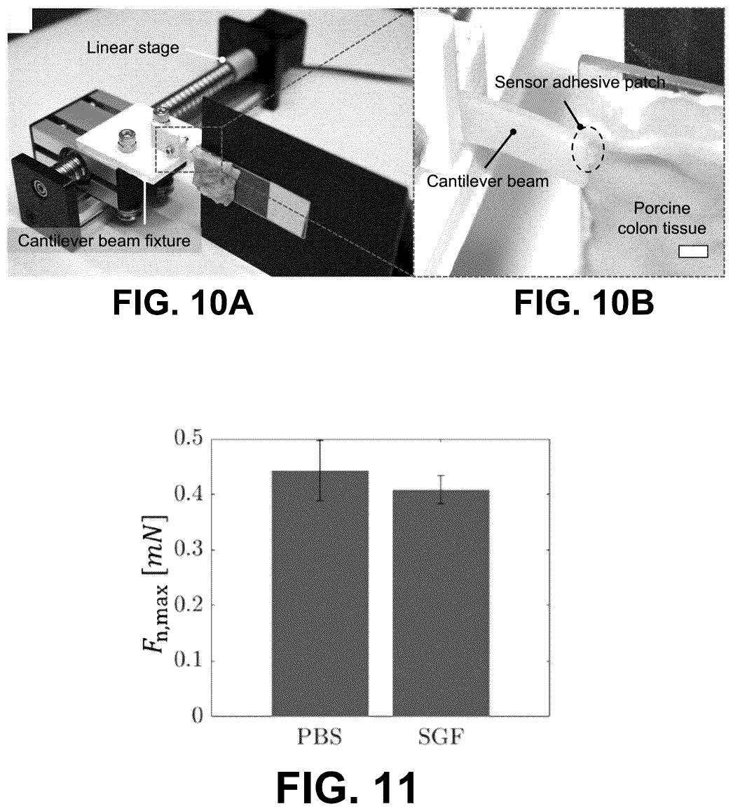

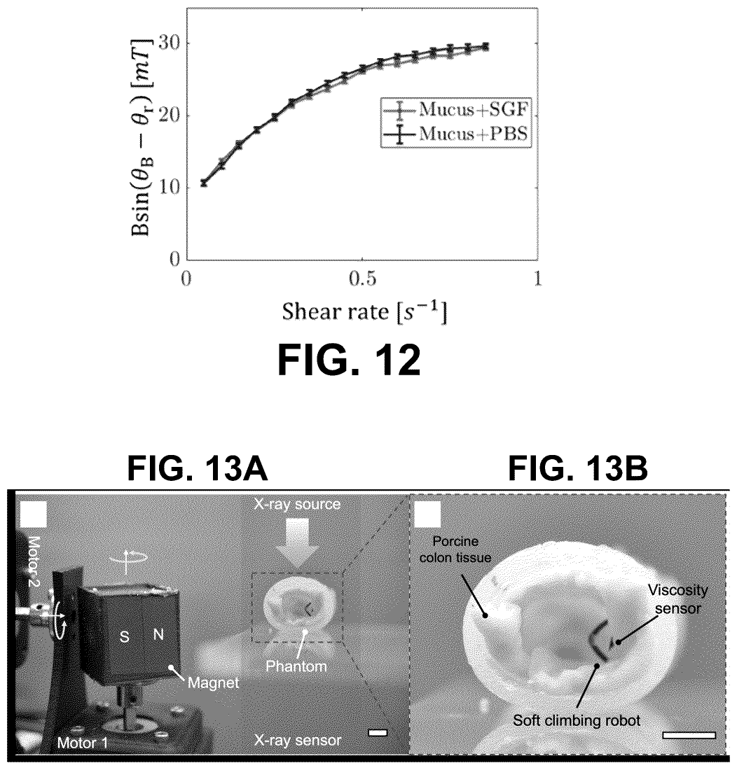

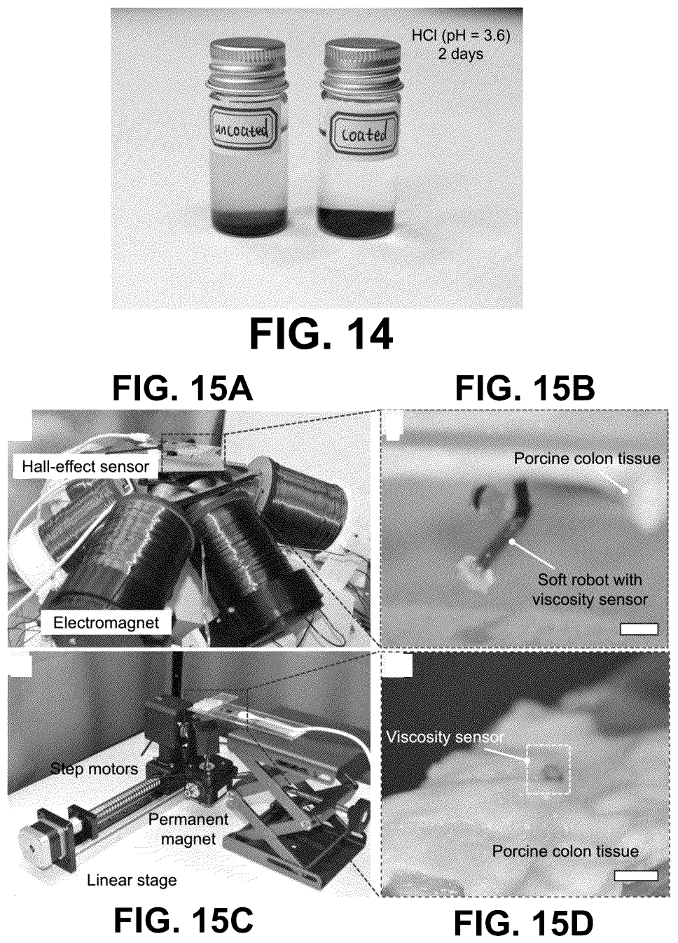

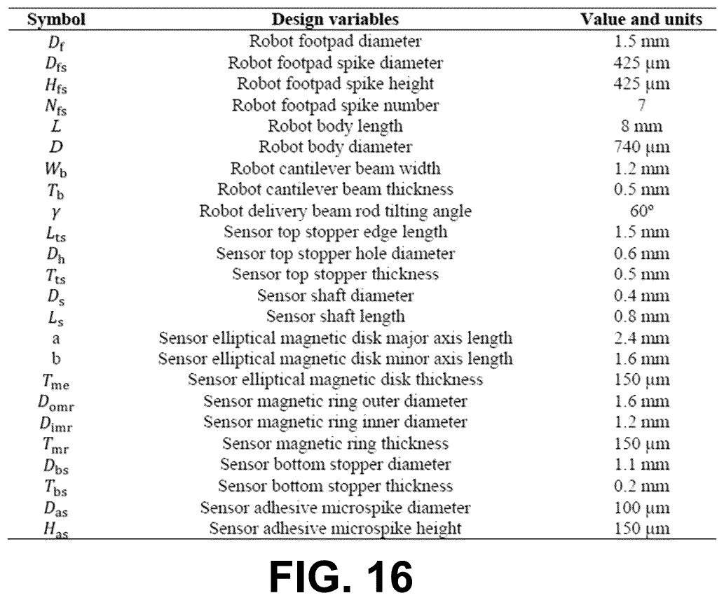

Preparing cantilever beam for characterizing the sensor anchoring forces. To prepare the cantilever beam for quantifying the robot-tissue adhesion, Mold Max-40 (Smooth-On Inc.) and Mold Max-60 (Smooth-On Inc.) were poured onto an acrylic glass substrate with a 700-μm-thick spacer. The uncured material was scraped with a razor blade and cured on the hotplate at 80° C. for two hours. Subsequently, the Mold Max-40 and Mold Max-60 were cut into beams of 12.5 mm by 5 mm by 700 μm using the LPKF U4 laser machine. For the normal anchoring force test, a viscosity sensor without the magnetic spinner was glued on the tip of the cantilever beam made of Mold Max-40. The beam was clamped with a 3D printed clamper and connected to a linear motion stage controlled by a step motor as shown in FIG. 10. The sensor was first pushed against the porcine colon tissue with a controlled displacement of the clamper and thus a controlled loading force for about 1.5 mins. The beam was then slowly pulled away from the tissue until the sensor was fully detached from the tissue surface. For the shear anchoring force, a viscosity sensor without the magnetic spinner or the PDMS shaft was first loaded on porcine colon tissues using the Mold Max-60 beam controlled by a linear motion stage. The sensor was pushed against the porcine colon tissue similar to the normal anchoring force test, with a controlled displacement of the clamper to apply the desired loading force for 1.5 mins. After loading, the cantilever beam rotates 90 degrees so that it can apply a shear force on the sensor for quantifying the shear anchoring force.

In addition to the foregoing, the various embodiments of the present disclosure include, but are not limited to, the embodiments set forth in the following clauses:
Clause 1—A sensor, comprising a rotating magnetic spinner disposed at a first end of a shaft and configured to rotate about the shaft; a foot disposed at a second end of the shaft; and a plurality of microspikes disposed on a distal surface of the foot.
Clause 2—The sensor of clause 1, wherein the rotating magnetic spinner has a programmed magnetization profile.
Clause 3—The sensor of clause 1 or 2, wherein the rotating magnetic spinner further comprises a magnetic ring disposed about the shaft and positioned near the first end of the shaft; and a magnetic disk disposed on the magnetic ring, a planar surface of the magnetic disk being perpendicular to a longitudinal axis of the magnetic ring.
Clause 4—The sensor of clause 3, wherein the magnetic disk is an ellipse-shaped disk.
Clause 5—The sensor of any of clauses 1-4, wherein the rotating magnetic spinner is formed form a mixture of Polydimethylsiloxane (PDMS) and neodymium, iron, and boron (NdFeB) magnetic particles.
Clause 6—The sensor of any of clauses 1-5, further comprising a cap disposed at the first end of the shaft, the cap having a hole configured to receive a delivery member.
Clause 7—A soft robot, comprising a magnetic robot body; a plurality of footpads, individual footpads of the plurality of footpads being disposed at a respective end of the magnetic robot body; and a delivery member having a first end connected to the magnetic robot body and a second end configured to attach to a sensor.
Clause 8—The soft robot of clause 7, wherein the magnetic robot body comprises a shaft having a first end with a first footpad and a second end with a second footpad.
Clause 9—The soft robot of clause 7 or 8, wherein the magnetic robot body is formed from a mixture of silicone rubber, silicone gel, and NdFeB microparticles in a 318 ratio by weight.
Clause 10—The soft robot of any of clauses 7-9, wherein the magnetic robot body has a programmed magnetization profile.
Clause 11—The soft robot of clause 10, wherein the programmed magnetization profile is configured to cause the magnetic robot body to perform a tumbling end-over-end motion when acted upon by a rotating magnetic field.
Clause 12—The soft robot of any of clauses 7-11, wherein each of the plurality of footpads is formed from PDMS.
Clause 13—The soft robot of any of clauses 7-12, wherein each of the plurality of footpads comprises a half-spherical footpad having an adhesive coating.
Clause 14—The soft robot of clause 13, wherein the adhesive coating comprises a chitosan-based bioadhesive.
Clause 15—The soft robot of any of clauses 7-14, wherein the delivery member further comprises a connector rod extending from the second end of the delivery member, the connector rod configured to fit into a reciprocal hole on the sensor.
Clause 16—A system, comprising a sensor of any of clauses 1-6; a soft robot any of clauses 7-15; and a magnetic actuator configured to produce a rotating magnetic field.
Clause 17—The system of clause 16, wherein the magnetic actuator is actuated to cause the soft robot to tumble to a designated location.
Clause 18—The system of clause 17, wherein the magnetic actuator is actuated to cause the delivery member to position the sensor at the designated location.
Clause 19—The system of clause 17 or 18, wherein the magnetic actuator is actuated to cause the delivery member to deliver the sensor to the designated location.
Clause 20—The system of any of clauses 16-19, wherein the magnetic actuator is actuated to cause the rotating magnetic spinner to rotate.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A sensor, comprising:
a rotating magnetic spinner disposed at a first end of a shaft and configured to rotate about the shaft;
a foot disposed at a second end of the shaft; and
a plurality of microspikes disposed on a distal surface of the foot.

2. The sensor of claim 1, wherein the rotating magnetic spinner has a programmed magnetization profile.

3. The sensor of claim 1, wherein the rotating magnetic spinner further comprises:
a magnetic ring disposed about the shaft and positioned near the first end of the shaft; and
a magnetic disk disposed on the magnetic ring, a planar surface of the magnetic disk being perpendicular to a longitudinal axis of the magnetic ring.

4. The sensor of claim 3, wherein the magnetic disk is an ellipse-shaped disk.

5. The sensor of claim 1, wherein the rotating magnetic spinner is formed form a mixture of Polydimethylsiloxane (PDMS) and neodymium, iron, and boron (NdFeB) magnetic particles.

6. The sensor of claim 1, further comprising a cap disposed at the first end of the shaft, the cap having a hole configured to receive a delivery member.

7. A soft robot, comprising:
a magnetic robot body;
a plurality of footpads, individual footpads of the plurality of footpads being disposed at a respective end of the magnetic robot body; and
a delivery member having a first end connected to the magnetic robot body and a second end configured to attach to a sensor.

8. The soft robot of claim 7, wherein the magnetic robot body comprises a shaft having a first end with a first footpad and a second end with a second footpad.

9. The soft robot of claim 7, wherein the magnetic robot body is formed from a mixture of silicone rubber, silicone gel, and NdFeB microparticles in a 3:1:8 ratio by weight.

10. The soft robot of claim 7, wherein the magnetic robot body has a programmed magnetization profile.

11. The soft robot of claim 10, wherein the programmed magnetization profile is configured to cause the magnetic robot body to perform a tumbling end-over-end motion when acted upon by a rotating magnetic field.

12. The soft robot of claim 7, wherein each of the plurality of footpads is formed from PDMS.

13. The soft robot of claim 7, wherein each of the plurality of footpads comprises a half-spherical footpad having an adhesive coating.

14. The soft robot of claim 13, wherein the adhesive coating comprises a chitosan-based bioadhesive.

15. The soft robot of claim 7, wherein the delivery member further comprises a connector rod extending from the second end of the delivery member, the connector rod configured to fit into a reciprocal hole on the sensor.

16. A system, comprising:
a sensor having a rotating magnetic spinner disposed at a first end of a shaft and configured to rotate about the shaft;
a soft robot, having a magnetic robot body, one or more footpads, individual footpads of the one or more footpads being disposed at a respective end of the magnetic robot body, and a delivery member having a first end connected to the magnetic robot body and a second end configured to attach to the sensor; and
a magnetic actuator configured to produce a rotating magnetic field to act upon the sensor.

17. The system of claim 16, wherein the magnetic actuator is actuated to cause the soft robot to tumble to a designated location.

18. The system of claim 17, wherein the magnetic actuator is actuated to cause the delivery member to position the sensor at the designated location.

19. The system of claim 17, wherein the magnetic actuator is actuated to cause the delivery member to deliver the sensor to the designated location.

20. The system of claim 16, wherein the magnetic actuator is actuated to cause the rotating magnetic spinner to rotate.
